(19) United States
(12) Patent Application Publication
(10) Pub. No.: US 2025/0282584 A1
(43) Pub. Date: Sep. 11, 2025

(54) FULL-UNIT LIFTIING METHOD FOR QUAYSIDE CONTAINER CRANE

(71) Applicant: NANJING PORT-MACHINERY & HEAVY-INDUSTRY MANUFACTURE CO., LTD, Nanjing (CN)

(72) Inventors: Chuanping ZHANG, Nanjing (CN); Qiang LU, Nanjing (CN); Lei PAN, Nanjing (CN); Shaonan XIE, Nanjing (CN); Guofang LIU, Nanjing (CN); Kehai YAO, Nanjing (CN); Junwu GAO, Nanjing (CN); Hailei WANG, Nanjing (CN); Wei LIU, Nanjing (CN)

(21) Appl. No.: 19/073,279

(22) Filed: Mar. 7, 2025

(30) Foreign Application Priority Data
Mar. 11, 2024 (CN) 202410269885.9

(51) Int. Cl. B66C 19/00; B66C 13/04

(52) U.S. Cl. CPC B66C 19/002; B66C 13/04

(57) ABSTRACT

A full-unit lifting method for a quayside container crane includes calculating an overall center position of gravity of the quayside container crane full-unit; estimating a lifting height and a floating amplitude required by a main hook of a floating crane according to a water level differential at a dock and a height of the quayside container crane full-unit; selecting the floating crane and obtaining detailed parameters thereof according to basic lifting conditions of the floating crane; selecting a type of the main hook according to a weight of the quayside container crane full-unit, checking whether an interference between the boom of the floating crane and the front boom occurs, and determining an inclination angle of the floating crane during lifting; calculating a load on the lifting wire rope and selecting the lifting wire rope and a shackle; making preparations before lifting; and performing lifting at the dock.

### CROSS-REFERENCE TO RELATED APPLICATIONS

The present application claims the priority benefit of China patent application No. 202410269885.9, filed on Mar. 11, 2024. The entirety of China patent application No. 202410269885.9 is hereby incorporated by reference herein and made a part of this specification.

### TECHNICAL FIELD

The present application relates to a technical field of lift of quayside container crane, and in particular, to a full-unit lifting method for a quayside container crane.

### BACKGROUND

A Container Quayside Crane (abbreviated as QCC) is a primary equipment for loading and unloading containers between a container vessel and an apron. The quayside container crane primarily includes a front boom, a rear boom, a gantry frame structure, a machinery house, a front tie link, a rear tie link, a traveling mechanism and the like.

At present, there are two main methods for installing quayside container cranes after being transported to a dock.

The first method involves preliminary assembly of the quayside container crane into several major modules at a manufacturing facility, such as the front boom, the rear boom (including the machinery house, a trapezoidal frame, and a rear tie link), left and right portal legs, a lower cross beam, a traveling trolley and the like. These modules are transported to the dock and assembled on-site by using floating cranes and other lifting equipment according to a general assembly process, and key steps include: 1, marking reference lines based on the crane's gauge and base; 2, arranging lifting travelling mechanisms according to the marked lines and fixing the traveling trolley through support; 3, installing two lower cross beams, and connecting the lower cross beams to the traveling trolley through bolted joints; 4, lifting the left and right portal legs onto the lower cross beams respectively, and welding them and securing wind ropes after the left and right portal legs are vertically oriented; 5, lifting a rear boom assembly (including a rear boom, a machinery house, a trapezoidal frame, a rear tie link and an upper cross beam) onto the gantry frame and welding the rear boom assembly after horizontal orientation; 6, lifting the front boom and assembling the front boom with a hinge pin at a hinge point of the rear boom, and maintaining slight upward tilt of the front boom; 7, installing the front tie link and leveling the front boom; and 8, threading wire ropes for mechanisms, connecting junction boxes, conducting installation inspections, lubricating, and preparing for power-on debugging.

The second method involves assembling and debugging the quayside container crane full-unit at the manufacturing facility according to a general assembly process and transporting the full-unit to the user terminal. During the transportation, wheel parts of the traveling mechanism of the quayside container crane are steered by 90 degrees. The quayside container crane is winched via a winch to the user terminal along rails laid between the terminal and transport vessel through roll-on/roll-off (RO/RO) operations.

The manufacturing facility provides superior construction conditions for full-unit assembly of the quayside container crane, whereas on-site assembly at the user terminal faces constrained construction conditions that compromise overall assembly quality. Moreover, extended durations for welding and assembly operations at the user terminal occupy valuable terminal operational areas, significantly impacting port productivity.

Although the RO/RO method reduces construction time, it imposes stringent water level requirements. This method becomes infeasible during dry seasons along the Yangtze River with a large water level differential. Additionally, RO/RO operations require extensive preparatory work, including pre-engineered wheel orientation in the traveling mechanism and pre-fabrication of specialized rail beams for the rolling process, resulting in higher costs.

While the RO/RO method remains a prevalent installation approach, its applicability is constrained by the water level of the terminal. For inland river terminals experiencing winter low-water periods (particularly with water level differentials exceeding 5 meters), implementing RO/RO operations necessitates constructing elevated rail support beams, which incurs substantial costs and complicates transportation reinforcement measures.

### SUMMARY

The present application aims to provide a full-unit lifting method for a quayside container crane. After completing the installation and commissioning of the quayside container crane full-unit at the manufacturing facility, it is transported to a user terminal. During onshore transfer at the user terminal, this method eliminates dependency on terminal water levels by lateral lifting the quayside container crane full-unit via a floating crane to the terminal. Compared to the roll-on/roll-off (RO/RO) methods, this approach achieves lower costs under conditions of significant water level differentials, offers greater operational convenience, and requires substantially shorter construction time, which is typically completed within a single day.

To achieve the above object, the technical solution of the present application is as follows,

A full-unit lifting method for a quayside container crane includes following steps:
step 1: calculating an overall center position of gravity of the quayside container crane full-unit;
step 2: estimating a lifting height and a floating amplitude required by a main hook of a floating crane according to a water level differential at a dock and a height of the quayside container crane full-unit;
step 3: selecting the floating crane and obtaining detailed parameters of the floating crane according to basic lifting conditions of the floating crane;
step 4: selecting a type of the main hook of the floating crane according to a weight of the quayside container crane full-unit, checking whether an interference between the boom of the floating crane and the front boom occurs, and determining an inclination angle of the floating crane during lifting;
step 5: calculating a load on the lifting wire rope and making selection of the lifting wire rope and a shackle;
step 6: making preparations before lifting; and
step 7: performing lifting operation at the dock.

Further, the step 1 specifically includes calculating a center of gravity of each of assemblies of the quayside container crane full-unit according to a design drawing of the quayside container crane full-unit, summarizing the centers of gravity of the assemblies of the quayside container crane full-unit into a center of gravity position table, and obtaining an overall center of gravity position G (x, y, z) of the quayside container crane full-unit by summing values of the centers of gravity of the assemblies of the quayside container crane full-unit in the center of gravity position table.

Further, the center of gravity of each of the assemblies of the quayside container crane full-unit is calculated by defining an intersection of a left-right symmetry central plane of the quayside container crane full-unit, an upper plane of a rail and a longitudinal central plane of a waterside rail as an origin, and defining a direction of a front boom as an x-axis positive direction.

Further, the water level differential at the dock h₁ and the height of the quayside container crane full-unit H in the step 2 are known parameters.

Further, the basic lifting conditions in the step 3 are that a maximum lifting height of the main hook of the floating crane h₄ₘₐₓ>the height of the quayside container crane full-unit H+a length of the lifting wire rope C×sin γ, where C is the length of the lifting wire rope and γ is an angle between the lifting wire rope and the horizontal plane, and the detailed parameters of the floating crane include a height from a deck surface of the floating crane to a water surface h₂, a height from the deck surface of the floating crane to a lower hinge joint of a boom of the floating crane h₃, a length of the boom of the floating crane L₁, an angle between the boom of the floating crane and a horizontal plane α, a lifting height of the main hook of the floating crane h₄, a height from the main hook of the floating crane to an upper pulley at the boom of the floating crane h₅, a radius of the boom of the floating crane R, a width of the floating crane B, a length of the floating crane L, and a distance from the lower hinge joint of the boom of the floating crane to a front end of the floating crane L₃, where R=L₁×cos α, h₁+h₄+h₅-h₂+h₃+L₁×sin α, h₄+h₅ is a constant, h₄ and h₅ are not constant values, h₅ has a minimum value h₅ₘᵢₙ, when h₅=h₅ₘᵢₙ, h₄ reaches its maximum value h₄ₘₐₓ.

Further, the length of each of the four lifting wire ropes C is 24 m, the angle γ between the four lifting wire ropes and the horizontal plane is 60° at minimum, and the height of the main hook to the upper pulley at the boom of the floating crane h₅ has a minimum value h₅ₘᵢₙ of 5 meters.

Further, the step 4 specifically includes when the weight of the quayside container crane full-unit exceeds 700 t, a floating crane with two main hooks is selected, whereby the length of the boom of the floating crane L₁, a distance between two lower hinge joints of the floating crane B₁, a distance between two main hooks at an uppermost end of the floating crane B₂, a length of a straight edge of the boom of the floating crane L₂, and an angle φ between an inclined edge and the straight edge of the boom of the floating crane are satisfied with

$$ϕ = arctan \frac{{B}_{\text{?}} - {B}_{2}}{2 ( {L}_{\text{?}} - {L}_{\text{?}} )} \text{?}$$

$$\text{?} \text{indicates text missing or illegible when filed}$$

an angle θ between the boom of the floating crane and a dock shoreline, a center of a connecting line between the two main hooks of the floating crane coincides with the overall center of gravity position of the quayside container crane full-unit in a top view, a height of a first main hook of the two main hooks to the dock surface h₄′, and a height of a second main hook of the two main hooks to the dock surface h₄″ are satisfied with h₄′=h₂+h₃+L₁×sin α−h₁−h₅′; h₄″=h₂+h₃+L₁×sin α−h₁−h₅″; a position of the first main hook is set as DG₁ (x₅, y₅, z₅),

$${x}_{5} = x - \frac{{B}_{2}}{2} \times sin θ , {y}_{5} = y + \frac{{B}_{2}}{2} \times cos θ , {z}_{5} = {h}_{4}^{′} ;$$

a position of the second main hook is set as DG₂ (x₆, y₆, z₆),

$${x}_{6} = x + \frac{{B}_{2}}{2} \times sin θ , {y}_{6} = y - \frac{{B}_{2}}{2} \times cos θ , {z}_{6} = {h}_{4}^{″} ,$$

assuming that in the top view, an intersection between the front boom and the boom of the floating crane is t(xₜ, yₜ, zₜ), it is obtained as:

$${y}_{\text{?}} - {y}_{\text{?}} = \frac{{B}_{2}}{2} , {y}_{\text{?}} = {y}_{6} - \frac{{B}_{4}}{2} , \frac{{y}_{6} - {y}_{1}}{{x}_{\text{?}} - {x}_{6}} = tan ( \frac{π}{2} - θ - ϕ ) ,$$

$${x}_{\text{?}} = {x}_{6} + \frac{{B}_{4}}{2 tan ( \frac{π}{2} - θ - ϕ )} ,$$

$${R}^{′} = \frac{{y}_{\text{?}} - {y}_{\text{?}}}{sin ( \frac{π}{2} - θ - ϕ )} cos ϕ = \frac{{B}_{4}}{2 sin ( \frac{π}{2} - θ - ϕ )} cos ϕ , {z}_{t} = {z}_{6} + {h}_{5} \text{?} {R}^{′} \times cot α ,$$

$$\text{?} \text{indicates text missing or illegible when filed}$$

whereby a basic condition for judging whether the interference between the boom of the floating crane and the front boom occurs is zₜ>the height of the front boom of the quayside container crane h₆, when the interference occurs, a re-check is performed by adjusting the angle θ between the boom of the floating crane and the dock, a distance D between the floating crane and an apron is checked, a corner point of the floating crane closest to the apron is set as n (xₙ, yₙ, zₙ), D is obtained by calculating xₙ,

$${x}_{\text{?}} = x + ( R - {L}_{\text{?}} ) \times cos ( \frac{π}{2} - θ - ϕ ) - \frac{B}{2} \times cos θ ,$$

$$D = {x}_{\text{?}} - {B}_{\text{?}} = x + ( R - {L}_{\text{?}} ) \times cos ( \frac{π}{2} - θ - ϕ ) - \frac{B}{2} \times cos θ - {B}_{\text{?}} ,$$

$$\text{?} \text{indicates text missing or illegible when filed}$$

in order to prevent the floating crane from colliding due to a fact that the floating crane is too close to the apron during lifting, D possesses a minimum safe distance, and a basic condition for determining whether a safe distance between the floating crane and the apron is enough is D>2 m.

Further, the step 5 specifically includes the position of the first main hook is DG₁ (x₅, y₅, z₅), and

$${x}_{5} = x - \frac{{B}_{2}}{2} \times sin θ , {y}_{5} = y + \frac{{B}_{2}}{2} \times cos θ , {z}_{5} = {h}_{4}^{′} ,$$

the position of the second main hook is DG₂ (x₆, y₆, z₆), and

$${x}_{6} = x + \frac{{B}_{2}}{2} \times sin θ , {y}_{6} = y - \frac{{B}_{2}}{2} \times cos θ , {z}_{6} = {h}_{4}^{″} ,$$

positions of four lifting lugs at the quayside container crane full-unit are obtained by measuring dimensions on the design drawing as: D₁ (x₁, y₁, z₁), D₂ (x₂, y₂, z₂), D₃ (x₃, y₃, z₃), D₄ (x₄, y₄, z₄), lengths of four lifting wire ropes are respectively calculated as follows: the length of a first lifting wire rope of the four lifting wire ropes is C₁=\sqrt{(x₅−x₁)²+(y₅−y₁)²+(z₅−z₁)²}, the length of a second lifting wire rope of the four lifting wire ropes is C₂=\sqrt{(x₆−x₃)²+(y₆−y₃)²+(z₆−z₂)²}, the length of a third lifting wire rope of the four lifting wire ropes is C₃=\sqrt{(x₅−x₃)²+(y₅−y₃)²+(z₅−z₃)²}, the length of a fourth lifting wire rope of the four lifting wire ropes is C₄=\sqrt{(x₆−x₄)²+(y₆−y₄)²+(z₆−z₄)²}; the height h₄′ of the first main hook and the height h₄″ of the second main hook are calculated by setting the length C₂ of the second lifting wire rope and the length C₃ of the third lifting wire rope, so as to obtain the length C₁ of the first lifting wire rope and the length C₄ of the fourth lifting wire rope, an then the angle γ between each of the four lifting wire ropes and a horizontal plane exceeds 60°, the angle between each of the four lifting wire ropes and the horizontal plane is calculated as follows:

$${γ}_{\text{?}} = arcsin ( \frac{{z}_{5} - {z}_{\text{?}}}{{C}_{1}} ) , {γ}_{\text{?}} = arcsin ( \frac{{z}_{6} - {z}_{2}}{{C}_{2}} ) ,$$

$${γ}_{3} = arcsin ( \frac{{z}_{5} - {z}_{3}}{{C}_{3}} ) , {γ}_{4} = arcsin ( \frac{{z}_{6} - {z}_{4}}{{C}_{4}} ) \text{?}$$

$$\text{?} \text{indicates text missing or illegible when filed}$$

and then the load on each of the four lifting wire rope is calculated as follows: since the gravity of the floating crane is vertically downward and the center of the connecting line between the two main hooks coincides with the overall center of gravity position of the quayside container crane full-unit in the top view, a load on the first main hook and a load on the second main hook is substantially balanced, it is obtained that a vertical downward load on each of the two main hooks is

$$\frac{Q}{2}$$

when a total weight Q of the quayside container crane is obtained according to the design drawing, so that the load on the first lifting wire rope, the load on the second lifting wire rope, the load on the third lifting wire rope and the load on the fourth lifting wire rope are respectively calculated with the first lifting wire rope C₁ and the third lifting wire rope C₃ sharing a first main hook while the second lifting wire rope C₂ and the fourth lifting wire rope C₄ sharing the second main hook, based on that a resultant force in a vertical direction of two of the four lifting wire ropes of one of the two main hooks is a lifting weight

$$\frac{Q}{2} ,$$

and a resultant force in a horizontal direction is 0, it is obtained that

$${F}_{\text{?}} \times sin {γ}_{\text{?}} + {F}_{\text{?}} \times sin {γ}_{\text{?}} = \frac{Q}{2} ,$$

$$\text{?} \text{indicates text missing or illegible when filed}$$

F₁×cos γ₁=F₃×cos γ₃;

$${F}_{\text{?}} \times sin {γ}_{\text{?}} + {F}_{4} \times sin {γ}_{4} = \frac{Q}{2} , {F}_{2} \times cos {γ}_{2} = {F}_{4} \times cos {γ}_{4} ,$$

$$\text{?} \text{indicates text missing or illegible when filed}$$

the load on the first lifting wire rope, the load on the second lifting wire rope, the load on the third lifting wire rope and the load on the fourth lifting wire rope are obtained by solving equations respectively:

$${F}_{\text{?}} - \frac{Q}{2 ( sin {γ}_{\text{?}} + cos {γ}_{\text{?}} \times tan {γ}_{\text{?}} )} , {F}_{\text{?}} - \frac{Q}{2 ( sin {γ}_{\text{?}} + cos {γ}_{\text{?}} \times tan {γ}_{\text{?}} )} ,$$

$${F}_{\text{?}} - \frac{Q}{2 ( sin {γ}_{\text{?}} + cos {γ}_{\text{?}} \times tan {γ}_{\text{?}} )} , {F}_{\text{?}} - \frac{Q}{2 ( sin {γ}_{\text{?}} + cos {γ}_{\text{?}} \times tan {γ}_{\text{?}} )}$$

$$\text{?} \text{indicates text missing or illegible when filed}$$

according to the load on the first lifting wire rope, the load on the second lifting wire rope, the load on the third lifting wire rope and the load on the fourth lifting wire rope, a lifting wire rope having a diameter with a safety factor above 4 and a shackle with a safety coefficient above 1 are selected by referencing a wire rope breaking force table.

Further, the step 6 specifically includes before lifting, travelling a trolley to a maximum rear extension position of the rear boom, retracting an upper frame of a container hanger to its highest position, parking an elevator at a first floor, locking brakes of the assemblies in such a way, that the trolley and trailer trolley wheels are plugged by wedge blocks, to keep the front boom be horizontal; for a travelling mechanism, inserting wooden blocks at rotatable positions of eight-wheel equalizer beams and driving and driven bogies before the lifting, so as to prevent rotation; checking securing and fastening of the assemblies of the quayside container crane to ensure all movable components are fastened; disassembling all anchorages between the quayside container crane and a transport vessel; using two winches on a floating crane vessel to secure two portal legs obliquely opposite the quayside container crane before the lifting, diagonal portal legs of the quayside container crane are pulled by the two winches on the floating crane vessel after the lifting, to maintain a constant inclination angle between the floating crane and the quayside container crane.

Further, the step 7 of performing lifting operation at the dock further includes: 1) after a floating crane vessel arrives at a construction site, the floating crane vessel is positioned within 200 m offshore from a quay front line, the floating crane vessel inclines, a length of an anchor cable is adjusted with reference to barge parameters and water conditions of the dock, to realize operational processes of lifting, shifting, and parking; 2) after the floating crane vessel is positioned, all tools and equipment used during the lifting are comprehensively checked, the floating crane vessel is put into use after it is confirmed that no abnormal condition exists, and whether a lifting point of the equipment is consistent with a diameter of a shackle pin or not is checked, after checking, the angle of the boom is adjusted to a required angle, all mechanical parts of the floating crane vessel are rechecked, and the floating crane vessel is used after being confirmed to be intact; 3) the floating crane vessel is lifted by the two main hooks, the two main hooks are loosened above the equipment to be lifted, rigging suspended on the two main hooks in advance is attached to lifting lugs of the equipment in sequence, and reliability of each connection point is rechecked; 4) after preparation, the lifting is performed, when the lifting is 200 mm away, all starting equipment brakes, a component is suspended on the two main hooks for secondary braking, a static state is maintained, when there is no abnormal condition, the floating crane is started to lift the component to a preset height and is suspended in a static state, the object is horizontally lifted during the lifting, to avoid uneven height discrepancies between the two main hooks; 5) after the component is lifted, a towing belt of a tugboat is used to assist in shifting to an installation berth, and anchor positioning is performed at an installation site, the floating crane vessel is repositioned after arriving at the installation site by adjusting a length and an orientation of the anchor cable, so that the floating crane is positioned above the rail of the installation dock, and the floating crane is kept descending horizontally, so that the equipment in a suspended state is aligned to a position right above a placing point by 10 cm; 6) a placing position of the equipment is approved, the floating crane is commanded to loosen the two main hooks, and the equipment is placed at the placing point; 7) lifting construction is carried out until the lifting is finished, and all lifting tools are retracted and the floating crane vessel is withdrawn.

Compared with the existing technique, the present application can achieve at least one of the following beneficial effects:

1. According to the full-unit lifting method for the quayside container crane provided by the present application, the onshore installation time of the quayside container crane full-unit at the dock is significantly reduced. The quayside container crane full-unit may be lifted onto the dock within a single day, which minimizes dock occupancy and avoids disruptions to production.

2. With the angle between the floating crane and the front boom between 40 degrees to 50 degrees, center-of-gravity deviations of the quayside container crane are dynamically compensated by adjusting the position of the trolley along the boom. This enables reusable deployment of lifting accessories (e.g., wire ropes and shackles), making the method universally applicable to lifting operations of cranes of the same type.

3. The full-unit lifting method for the quayside container crane provided by the present application demonstrates high reliability, strong operability, and broad applicability. It can be directly extended to crane relocation on the dock and vessel unloader lifting operations with identical operational principles.

### BRIEF DESCRIPTION OF THE DRAWINGS

FIG. 1 is a schematic diagram of a structure of a quayside container crane full-unit according to the present application;

FIG. 2 is a schematic diagram of structural parts of the quayside container crane full-unit according to the present application;

FIG. 3 is a schematic diagram of an RO-on/RO-off process for the quayside container crane full-unit according to the present application;

FIG. 4 is a flow chart of a full-unit lifting method for the quayside container crane according to the present application;

FIG. 5 is a gravity center position table of the quayside container crane full-unit according to the present application;

FIG. 6 shows a gravity center position and a coordinate system of the quayside container crane full-unit according to the present application;

FIG. 7 schematically shows a first relevant parameter of lifting by a floating crane according to the present application;

FIG. 8 schematically shows a second relevant parameter of the lifting by the floating crane according to the present application;

FIG. 9 shows relevant parameters of a boom of the floating crane according to the present application;

FIG. 10 shows relevant parameters for determining whether the floating crane interferes with the front boom according to the present application;

FIG. 11 shows relevant parameters for determining whether there is a sufficient safe distance between the floating crane and an apron according to the present application; and

FIG. 12 is a top view of a lifting wire rope according to the present application.

### DETAILED DESCRIPTION

The present application will be further described in detail below in combination with the accompanying drawings and embodiments.

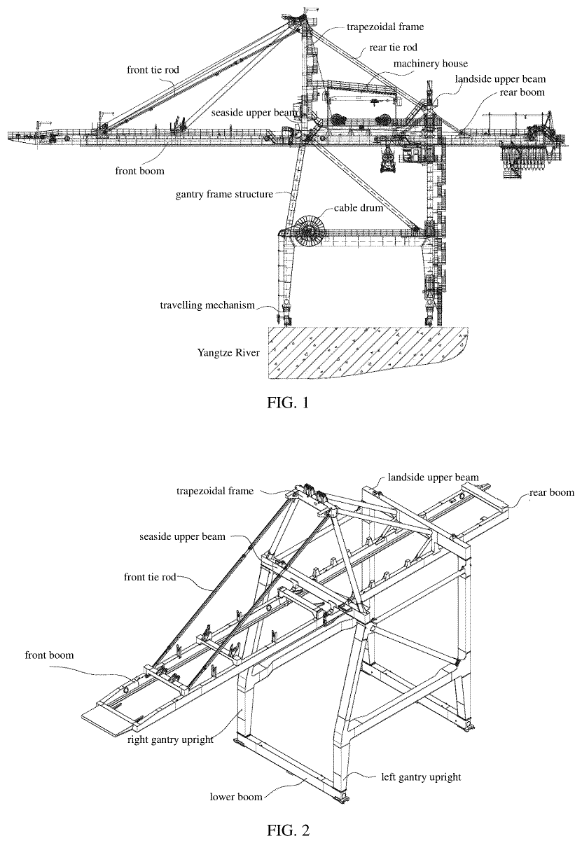

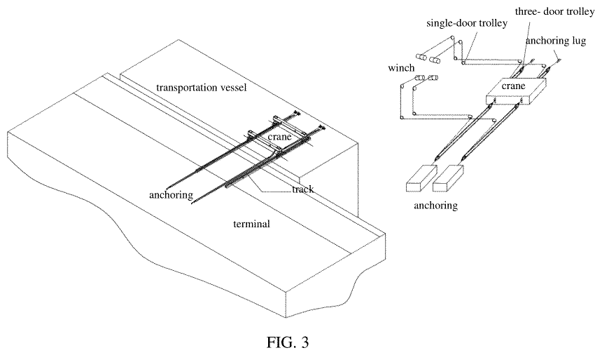

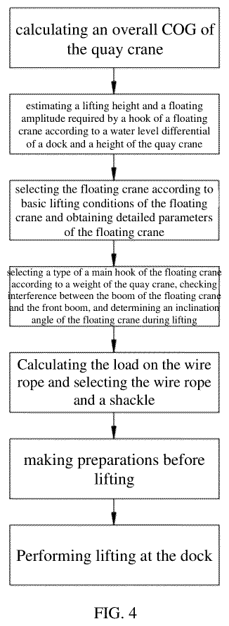

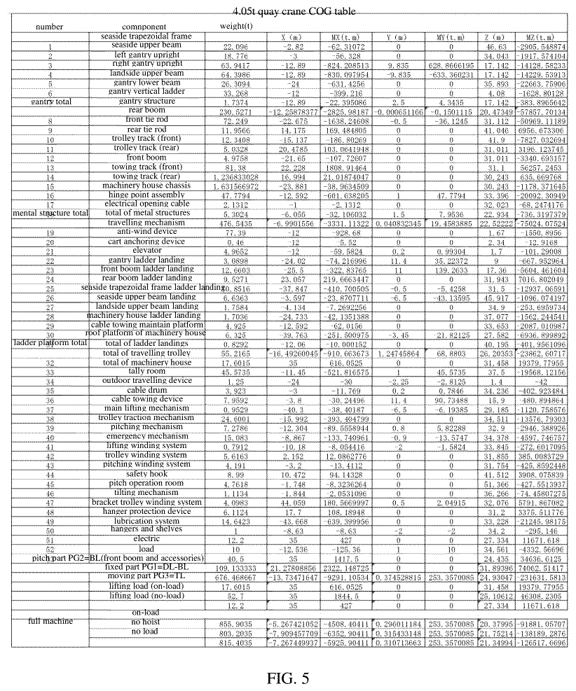

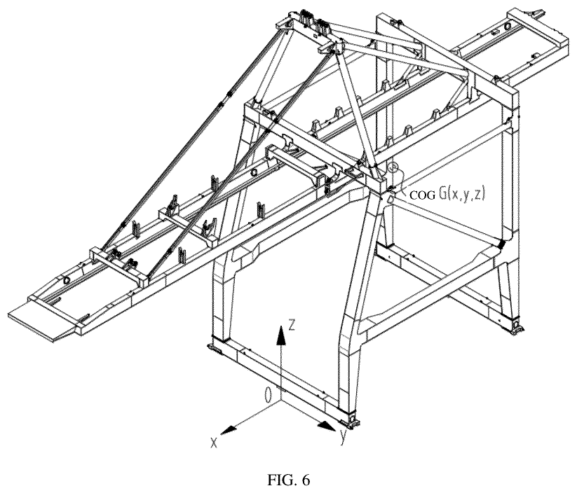

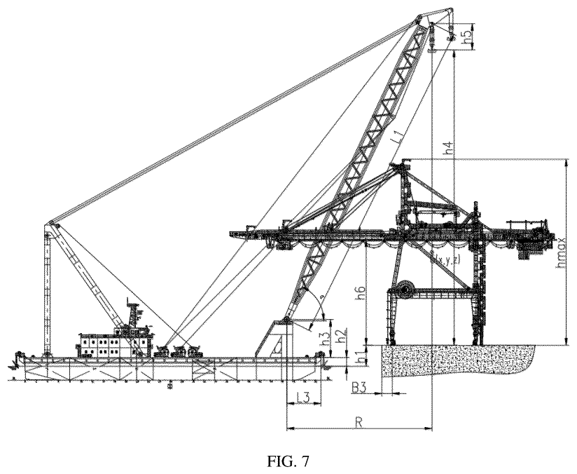

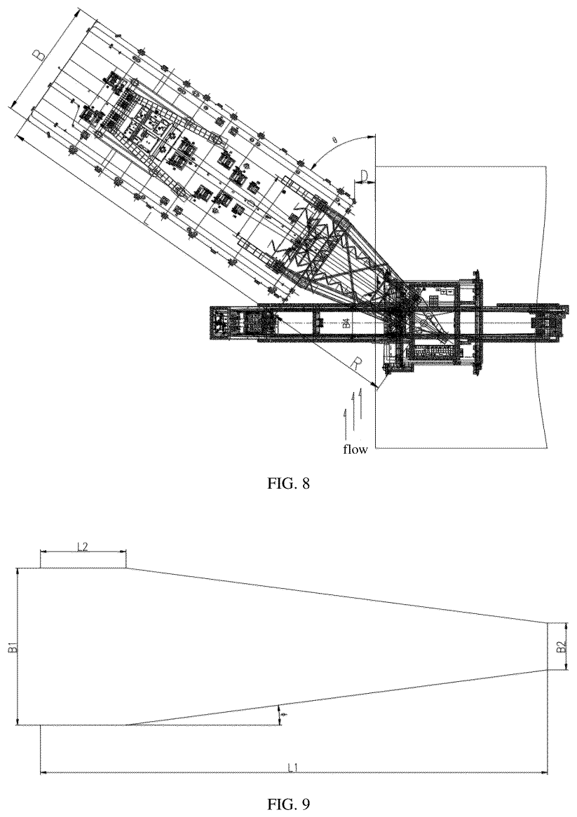

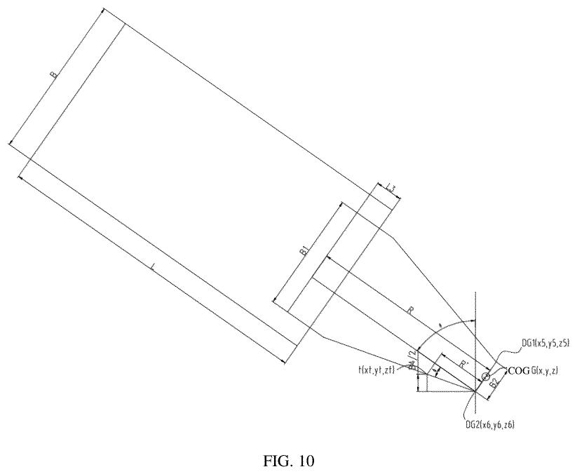

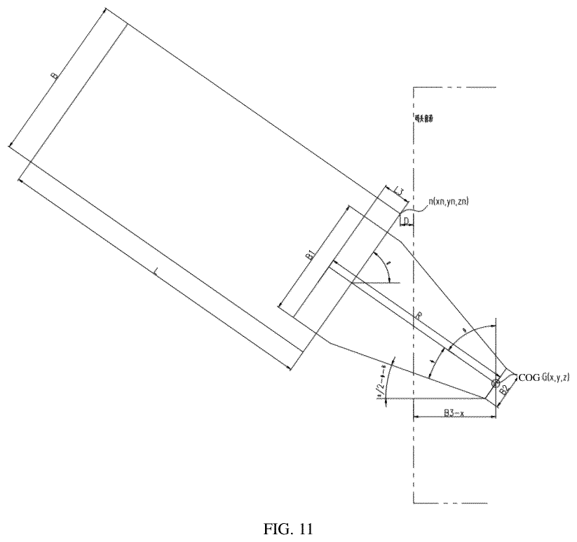

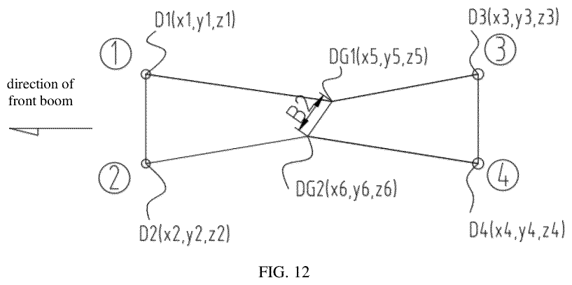

Referring to FIGS. 1 to 12, a full-unit lifting method for a quayside container crane specifically includes following steps.

1. Calculating an overall center of gravity (COG) of the quayside container crane: calculating a COG of each assembly of the quayside container crane full-unit according to a design drawing of the quayside container crane full-unit, by which an origin is defined as an intersection of a left-right symmetry central plane of the quayside container crane full-unit, an upper plane of a rail and a longitudinal central plane of a waterside rail, a direction of a front boom is defined an x-axis positive direction, summarizing the COG of the assemblies of the quayside container crane full-unit into a COG table, and obtaining the overall COG G (x, y, z) of the quayside container crane full-unit by summing values of the COG of the assemblies of the quayside container crane full-unit in the COG table.

2. Estimating a lifting height and a floating amplitude required by a hook of a floating crane according to a water level differential at a dock and a height of the quayside container crane full-unit, by which the floating crane is selected and detailed parameters thereof are obtained according to basic lifting conditions of the floating crane, and an outline diagram of the floating crane is drawn; known parameters include the water level differential at the dock h₁, the overall COG position of the quayside container crane full-unit G (x, y, z), position coordinates of four lifting lugs on the quayside container crane D1 (x₁, y₁, z₂), D2 (x₂, y₂, z₂), D3 (x₃, y₃, z₃), D4 (x₄, y₄, z₄), a height of the quayside container crane full-unit H, a height from the front boom to the plane of the rail h₆, a distance from the waterside rail to the apron B₃, a width of the front boom B₄; relevant parameters of the floating crane include a height from a deck surface of the floating crane to a water surface h₂, a height from the deck surface of the floating crane to a lower hinge joint of a boom of the floating crane h₃, a length of the boom of the floating crane L₁, an angle between the boom of the floating crane and a horizontal plane α, a lifting height of the hook of the floating crane h₄, a height from the hook of the floating crane to an upper pulley at the boom of the floating crane h₅, a radius of the boom of the floating crane R, a width of the floating crane B, a length of the floating crane L, and a distance from the lower hinge joint of the boom of the floating crane to a front end of the floating crane L₃, where R=L₁×cos α, generally α is 65°; h₁+h₄+h₅=h₂+h₃+L₁×sin α, h₄+h₅ is a constant. However, since the hook may move up and down through a lifting mechanism, h₄ and h₅ are not constant values, h₅ has a minimum value h₅ₘᵢₙ which is generally set to 5 m due to a minimum safe distance between the hook and the upper pulley of the boom; when h₅=h₅ₘᵢₙ, h₄ reaches its maximum value h₄ₘₐₓ, which is a basic condition for determining whether the floating crane may perform the lifting, namely a maximum lifting height of the hook of the floating crane h₄ₘₐₓ>the height of the quayside container crane full-unit H+a length of the lifting wire rope C×sin γ, where C is the length of the lifting wire rope and γ is an angle between the lifting wire rope and the horizontal plane, generally, the length of the lifting wire rope C is taken as 24 m, and the angle γ between the lifting wire rope and the horizontal plane is 60° at minimum.

3. Checking interference between the boom of the floating crane and the front boom, and determining an inclination angle of the floating crane during lifting. Since a weight of the quayside container crane full-unit typically exceeds 700 tons, the floating crane with two main hooks is required. The relevant parameters of the floating crane include the length of the boom of the floating crane L₁, a distance between two lower hinge joints of the floating crane B₁, a distance between two main hooks at an uppermost end of the floating crane B₂, a length of a straight edge of the boom of the floating crane L₂, and an angle φ between an inclined edge and the straight edge of the boom of the floating crane with

$$ϕ - arctan \frac{{B}_{1} - {B}_{2}}{2 ( {L}_{1} - {L}_{3} )} ;$$

as the two main hooks of the floating crane are adopted for lifting, the angle between the boom of the floating crane and the dock shoreline is θ, a center of a connecting line between the two hooks of the floating crane must coincide with the overall COG position of the quayside container crane full-unit in the top view. The lifting heights of the two hooks may be different (with a height difference not too large). It is assumed that a height from a first hook of the floating crane to the dock surface is h₄′, and a height from a second hook of the floating crane to the dock surface is h₄″, h₄′=h₂+h₃+L₁×sin α−h₁−h₅′; h₄″=h₂+h₃+L₁×sin α−h₁−h₅″. If a position of the first hook of the floating crane is set as DG₁ (x₅, y₅, z₅),

$${x}_{5} = x - \frac{{B}_{2}}{2} \times sin θ , {y}_{5} = y + \frac{{B}_{2}}{2} \times cos θ , {z}_{5} = {h}_{4}^{′} ;$$

if a position of the second hook of the floating crane is set as DG₂ (x₆, y₆, z₆),

$${x}_{6} = x + \frac{{B}_{2}}{2} \times sin θ , {y}_{6} = y - \frac{{B}_{2}}{2} \times cos θ , {z}_{6} = {h}_{4}^{″} ,$$

assuming that in the top view, an intersection between the front boom and the boom of the floating crane is t(xₜ, yₜ, zₜ), the following may be obtained as:

$${y}_{6} - {y}_{t} = \frac{{B}_{4}}{2} , \\ {y}_{t} = {y}_{6} - \frac{{B}_{4}}{2} , \\ \frac{{y}_{6} - {y}_{t}}{{x}_{t} - {x}_{6}} = tan ( \frac{π}{2} - θ - ϕ ) , \\ {x}_{t} = {x}_{6} + \frac{{B}_{4}}{2 tan ( \frac{π}{2} - θ - ϕ )} , \\ {R}^{′} = \frac{{y}_{6} - {y}_{t}}{sin ( \frac{π}{2} - θ - ϕ )} cos ϕ = \frac{{B}_{4}}{2 sin ( \frac{π}{2} - θ - ϕ )} cos ϕ , \\ {z}_{t} = {z}_{6} + {h}_{5} - {R}^{′} \times cot α ,$$

and the basic condition for determining the interference between the boom of the floating crane and the front boom includes: zₜ>the height of the front boom of the quayside container crane h₆; if interference occurs, re-check is performed by adjusting the angle θ between boom of the floating crane and the dock, where θ cannot be adjusted arbitrarily; θ is ensured not too small to avoid collision between a floating crane vessel and the dock, and thus it is also necessary to check a distance D between the floating crane and the apron; it is assumed that a corner point of the floating crane closest to the apron is n (xₙ, yₙ, zₙ), and D can be obtained by calculating xₙ;

$${x}_{n} = x + ( R - {L}_{3} ) \times cos ( \frac{π}{2} - θ - ϕ ) - \frac{B}{2} \times cos θ , \\ D = {x}_{n} - {B}_{3} = x + ( R - {L}_{3} ) \times cos ( \frac{π}{2} - θ - ϕ ) - \frac{B}{2} \times cos θ - {B}_{3} ,$$

in order to prevent the floating crane from colliding due to the fact that the floating crane is too close to the apron during lifting, D possesses the minimum safety distance, and the basic condition for determining whether a safe distance between the floating crane and the apron is enough is D>2 m.

4. Calculating a load on the wire rope and selecting the wire rope and shackles; the position of the first hook of the floating crane is DG₁ (x₅, y₅, z₅) and

$${x}_{5} = x - \frac{{B}_{2}}{2} \times sin θ , {y}_{5} = y + \frac{{B}_{2}}{2} \times cos θ , {z}_{5} = {h}_{4}^{′} ,$$

the position of the second hook of the floating crane is DG₂ (x₆, y₆, z₆), and

$${x}_{6} = x + \frac{{B}_{2}}{2} \times sin θ , {y}_{6} = y - \frac{{B}_{2}}{2} \times cos θ , {z}_{6} = {h}_{4}^{″} ,$$

the positions of four lifting lugs at the quayside container crane are obtained by measuring dimensions on the drawings as: D₁ (x₁, y₁, z₂), D₂ (x₂, y₂, z₂), D₃ (x₃, y₃, z₃), D₄ (x₄, y₄, z₄); then lengths of the four lifting wire ropes are as follows:
the length of a first lifting wire rope is C₁=\sqrt{(x₅−x₁)²+(y₅−y₁)²+(z₅−z₁)²}, the length of a second lifting wire rope is C₂=\sqrt{(x₆−x₂)²+(y₆−y₂)²+(z₆−z₂)²}, the length of a third lifting wire rope is C₃=\sqrt{(x₅−x₃)²+(y₅−y₃)²+(z₅−z₃)²}, the length of a fourth lifting wire rope is C₄=\sqrt{(x₆−x₄)²+(y₆−y₄)²+(z₅−z₁)²}, The heights h₄′ and h₄″ of the two hooks of the floating crane can be calculated by setting the length C₂ of the second lifting wire rope and the length C₃ of the third lifting wire rope, and the length C₁ of the first lifting wire rope and the length C₄ of the fourth lifting wire rope can be obtained; checking that the angle γ between each of the lifting wire ropes and the horizontal plane exceeds 60°. The angle between each of the lifting wire ropes and the horizontal plane is as follows:

$${γ}_{1} = arcsin ( \frac{{z}_{5} - {z}_{1}}{{C}_{1}} ) , {γ}_{2} = arc sin ( \frac{{z}_{6} - {z}_{2}}{{C}_{2}} ) , \\ {γ}_{3} = arcsin ( \frac{{z}_{5} - {z}_{3}}{{C}_{3}} ) , {γ}_{4} = arcsin ( \frac{{z}_{b} - {z}_{4}}{{C}_{4}} ) ;$$

The load on the lifting wire rope is calculated as follows: since the gravity is vertically downward, and since the center of the two hooks of the floating crane corresponds to the overall COG position of the quayside container crane full-unit, it can be considered that the loads on the two hooks of the floating crane is substantially balanced. A total weight Q of the quayside container crane may be known according to the design drawing, and it may be obtained that a vertical downward load on each of the hooks of the floating crane may be

$$\frac{Q}{2} ,$$

so that the load on each of the lifting wire ropes may be calculated as follows. The first lifting wire rope C₁ and the third lifting wire rope C₃ share one hook of the floating crane, and the second lifting wire rope C₂ and the fourth lifting wire rope C₄ share the other hook of the floating crane. According to that a resultant force in the vertical direction of the two lifting wire ropes of the same hook of the floating crane is a lifting weight

$$\frac{Q}{2} ,$$

and a resultant force in the horizontal direction should be 0, it may be obtained that

$${F}_{1} \times sin {γ}_{1} + {F}_{3} \times sin {γ}_{3} = \frac{Q}{2} ,$$

F₁×cos γ₁=F₃×cos γ₃;

$${F}_{2} \times sin {γ}_{2} + {F}_{4} \times sin {γ}_{4} = \frac{Q}{2} ,$$

F₂×cos γ₂=F₄×cos γ₄. The loads on the four wire ropes may be obtained by solving equations respectively

$${F}_{1} \frac{Q}{2 ( sin {γ}_{1} + cos {γ}_{1} \times tan {γ}_{3} )} , {F}_{3} \frac{Q}{2 ( sin {γ}_{3} + cos {γ}_{3} \times tan {γ}_{1} )} , \\ {F}_{2} \frac{Q}{2 ( sin {γ}_{2} + cos {γ}_{2} \times tan {γ}_{4} )} , {F}_{4} \frac{Q}{2 ( sin {γ}_{4} + cos {γ}_{4} \times tan {γ}_{2} )}$$

According to the loads on the wire ropes, a wire rope having a diameter with a safety factor above 4 and a shackle with a safety coefficient above 1 are selected by referencing a wire rope breaking force table.

Specifications and lengths of the wire rope and types of the shackle and the like are compiled into a table and are in one-to-one correspondence with the lifting lugs.

Example: length parameters of the wire rope are shown in the following table:

| position | length | | diameter | theoretical load | type of shackle |
|---|---|---|---|---|---|
| 1 | 22.6 | m | 150 mm | 280 t | 300 t |
| 2 | 22 | m | 150 mm | 330 t | 350 t |
| 3 | 22 | m | 150 mm | 337 t | 350 t |
| 4 | 24 | m | 150 mm | 277 t | 300 t |

5. Making preparations before lifting: before the lifting, travelling a trolley to a maximum rear extension position of the rear boom (adjustable based on the specific COG position); retracting an upper frame of a container hanger to its highest position, parking an elevator at a first floor, locking brakes of respective mechanisms, plugging the trolley and trailer trolley wheels by wedge blocks, and keeping the front boom horizontal; for a travelling mechanism, inserting wooden blocks at rotatable positions of the eight-wheel equalizer beams and driving and driven bogies before the lifting, so as to prevent rotation; checking the securing and fastening of all components of the quayside container crane to ensure all movable components are fastened firmly; disassembling all anchorages between the quayside container crane and the transport vessel; using two winches on the floating crane vessel to secure two portal legs obliquely opposite the quayside container crane before lifting (through the pre-adjusted lengths of the wire ropes, rotation due to insufficient horizontal stability after the quayside container crane may be prevented after the quayside container crane is hoisted, and the diagonal legs are pulled by the winches for protection), the diagonal portal legs of the quayside container crane must be pulled by the two winches on the floating crane vessel continuously after lifting, to maintain a constant inclination angle between the floating crane and the quayside container crane.

6. Performing lifting operation at the user dock including following steps.

1) After the floating crane arrives at a construction site, the floating crane is positioned within about 200 m offshore from the quay front line, the floating crane inclines at a certain angle (generally, an angle between an extension direction of the boom of the floating crane and the dock is) 50°, a length of an anchor cable is adjusted with reference to barge parameters and the water conditions of the dock, to ensure that operational processes of lifting, shifting, parking and the like may be achieved.

2) After the floating crane vessel is positioned, all tools and equipment used during lifting are comprehensively checked, the floating crane vessel may be put into use after it is confirmed that no abnormal condition exists, and whether a lifting point of the equipment is consistent with a diameter of a shackle pin or not is checked. After all of the checks are performed, the angle of the boom is adjusted to a required angle. All mechanical parts of the floating crane are rechecked, and the floating crane may be used after being confirmed to be intact.

3) The floating crane vessel are lifted by two main hooks, the hooks are loosened above equipment to be hoisted, rigging suspended on the hooks in advance is attached to lifting lugs of the equipment in sequence, and the reliability of each connection point is rechecked.

4) After it is confirmed that the preparation work is completed, the lifting operation is performed. When the lifting is 200 mm away, all starting equipment brakes, a component is suspended on the main hooks for secondary braking, and a static state is maintained. When there is no abnormal condition, the crane is started to hoist the component to a preset height and is suspended in the static state. The object is kept horizontally hoisted and slowly lifted in the lifting process, avoiding uneven height discrepancies between the two hooks.

5) After the component is stably hoisted, a towing belt of a tugboat is used to assist in slow shifting to the installation berth, and the component is anchored and positioned on the installation site. The floating crane vessel is repositioned after arriving at the installation site by adjusting the length and the orientation of the anchor cable. The crane is positioned above the rail of the installation dock, and kept descending horizontally and slowly, so that the equipment in the suspended state is aligned to the position right above the placing point by 10 cm.

6) the placing position of the equipment is approved, the floating crane is commanded to slowly loosen the hooks, and the equipment is stably placed at the placing point.

7) According to the construction process, lifting construction is carried out until the lifting is finished, and all lifting tools are retracted and the floating crane vessel is withdrawn.

The above description includes only preferred embodiments of the present application, and is not intended to limit the present application in any form, and therefore, any modifications, equivalent substitutions and improvements made to the above embodiments according to the technical principle of the present application, without departing from the scope of the technical solution of the present application, still fall within the protection scope of the technical solution of the present application.

What is claimed is:

1. A full-unit lifting method for a quayside container crane, comprising following steps:
step 1: calculating an overall center of gravity of the quayside container crane, comprising calculating a center of gravity of each of assemblies of the quayside container crane according to a design drawing of the quayside container crane, summarizing the centers of gravity of the assemblies of the quayside container crane into a center of gravity position table, and obtaining an overall center of gravity position (G (x, y, z)) of the quayside container crane by summing values of the centers of gravity of the assemblies of the quayside container crane in the center of gravity position table, wherein the center of gravity of each of the assemblies of the quayside container crane is calculated by defining an intersection of a left-right symmetry central plane of the quayside container crane, an upper plane of a rail and a longitudinal central plane of a waterside rail as an origin, and defining a direction of a front boom as an x-axis positive direction;
step 2: estimating a lifting height and a floating amplitude required by a main hook of a floating crane according to a water level differential at a dock and a height of the quayside container crane, wherein the water level differential at the dock (h₁) and the height of the quayside container crane (H) are known parameters;
step 3: selecting the floating crane and obtaining parameters of the floating crane according to basic lifting conditions of the floating crane, wherein the basic lifting conditions are that a maximum lifting height of the main hook of the floating crane (h₄ₘₐₓ) is greater than the height of the quayside container crane (H)+C×sin γ, where C is a length of a lifting wire rope and γ is an angle between the lifting wire rope and a horizontal plane, and the parameters of the floating crane comprise a height from a deck surface of the floating crane to a water surface (h₂), a height from the deck surface of the floating crane to a lower hinge joint of a boom of the floating crane (h₃), a length of the boom of the floating crane (L₁), an angle between the boom of the floating crane and the horizontal plane (α), the lifting height of the main hook of the floating crane (h₄), a height from the main hook of the floating crane to an upper pulley at the boom of the floating crane (h₅), a radius of the boom of the floating crane (R), a width of the floating crane (B), a length of the floating crane (L), and a distance from the lower hinge joint of the boom of the floating crane to a front end of the floating crane (L₃), where R=L₁×cos α, h₁+h₄+h₅=h₂+h₃+L₁×sin α, h₄+h₅ is a constant, h₄ and h₅ are not constant values, h₅ has a minimum value h₅ₘᵢₙ, when h₅−h₅ₘᵢₙ, h₄ reaches its maximum value h₄ₘₐₓ,
step 4: selecting a type of the main hook of the floating crane according to a weight of the quayside container crane, checking whether an interference between the boom of the floating crane and the front boom occurs, and determining an inclination angle of the floating crane during lifting, comprising: when the weight of the quayside container crane exceeds 700 t, a floating crane with two main hooks is selected, wherein the length of the boom of the floating crane (L₁), a distance between two lower hinge joints of the floating crane (B₁), a distance between the two main hooks at an uppermost end of the floating crane (B₂), a length of a straight edge of the boom of the floating crane (L₂), and an angle (φ) between an inclined edge and the straight edge of the boom of the floating crane are satisfied with
$$ϕ = arc \frac{{B}_{1} - {B}_{2}}{2 ( {L}_{1} - {L}_{3} )} ;$$
an angle between the boom of the floating crane and a dock shoreline (θ), a center of a connecting line between the two main hooks of the floating crane coincides with the overall center of gravity position of the quayside container crane in a top view, a height of a first main hook of the two main hooks to the dock surface (h₄′), and a height of a second main hook of the two main hooks to the dock surface (h₄″) are satisfied with h₄′=h₂+h₃+L₁×sin α−h₁−h₅′; h₄″=h₂+h₃+L₁×sin α−h₁−h₅″; a position of the first main hook is set as DG₁ (x₅, y₅, z₅),
$${x}_{5} = x - \frac{{B}_{2}}{2} \times sin θ , {y}_{5} = y + \frac{{B}_{2}}{2} \times cos θ , {z}_{5} = {h}_{4}^{′} ;$$
a position of the second main hook is set as DG₂ (x₆, y₆, z₆),
$${x}_{6} = x + \frac{{B}_{2}}{2} \times sin θ , {y}_{6} = y - \frac{{B}_{2}}{2} \times cos θ , {z}_{6} = {h}_{4}^{″} ,$$
assuming that in the top view, an intersection between the front boom and the boom of the floating crane is t(xₜ, yₜ, zₜ), it is obtained as:
$${y}_{\text{?}} - {y}_{\text{?}} = \frac{{B}_{4}}{2} , {y}_{\text{?}} = {y}_{\text{?}} - \frac{{B}_{4}}{2} , \frac{{y}_{\text{?}} - {y}_{\text{?}}}{{x}_{\text{?}} - {x}_{\text{?}}} = tan ( \frac{π}{2} - θ - ϕ ) ,$$
$${x}_{\text{?}} = {x}_{\text{?}} + \frac{{B}_{\text{?}}}{2 tan ( \frac{π}{2} - θ - ϕ )} ,$$
$${R}^{′} = \frac{{y}_{\text{?}} - {y}_{\text{?}}}{sin ( \frac{π}{2} - θ - ϕ )} cos ϕ = \frac{{B}_{\text{?}}}{2 sin ( \frac{π}{2} - θ - ϕ )} cos ϕ , {z}_{t} = {z}_{6} + {h}_{5} \text{?} {R}^{′} \times cot α ,$$
$$\text{?} \text{indicates text missing or illegible when filed}$$
wherein a basic condition for judging whether the interference between the boom of the floating crane and the front boom occurs is zₜ is greater than the height of the front boom of the quayside container crane (h₆), when the interference occurs, a re-check is performed by adjusting the angle (θ) between the boom of the floating crane and the dock, a distance (D) between the floating crane and an apron is checked, a corner point of the floating crane closest to the apron is set as n (xₙ, yₙ, zₙ), D is obtained by calculating xₙ,
$${x}_{\text{?}} = x + ( R - {L}_{\text{?}} ) \times cos ( \frac{π}{2} - θ - ϕ ) - \frac{B}{2} \times cos θ ,$$
$$D = {x}_{\text{?}} - {B}_{\text{?}} = x + ( R - {L}_{\text{?}} ) \times cos ( \frac{π}{2} - θ - ϕ ) - \frac{B}{2} \times cos θ - {B}_{\text{?}} ,$$
$$\text{?} \text{indicates text missing or illegible when filed}$$
in order to prevent the floating crane from colliding due to a fact that the floating crane is too close to the apron during lifting, D possesses a minimum safe distance, and a basic condition for determining whether a safe distance between the floating crane and the apron is enough is D>2 m;
step 5: calculating a load on the lifting wire rope and making selection of the lifting wire rope and a shackle, the position of the first main hook is DG₁ (x₅, y₅, z₅), and
$${x}_{5} = x - \frac{{B}_{2}}{2} \times sin θ , {y}_{5} = y + \frac{{B}_{2}}{2} \times cos θ , {z}_{5} = {h}_{4}^{′} ,$$
the position of the second main hook is DG₂ (x₆, y₆, z₆), and
$${x}_{6} = x + \frac{{B}_{2}}{2} \times sin θ , {y}_{6} = y - \frac{{B}_{2}}{2} \times cos θ , {z}_{6} = {h}_{4}^{″} ,$$
positions of four lifting lugs at the quayside container crane are obtained by measuring dimensions on the design drawing as: D₁ (x₁, y₁, z₁), D₂ (x₂, y₂, z₂), D₃ (x₃, y₃, z₃), D₄ (x₄, y₄, z₄), lengths of four lifting wire ropes are respectively calculated as follows:
a length of a first lifting wire rope of the four lifting wire ropes is
$${C}_{1} = \sqrt{{( {x}_{5} - {x}_{\text{?}} )}^{2} + {( {y}_{5} - {y}_{\text{?}} )}^{2} + {( {z}_{5} - {z}_{\text{?}} )}^{2}} ,$$
$$\text{?} \text{indicates text missing or illegible when filed}$$
a length of a second lifting wire rope of the four lifting wire ropes is
$${C}_{2} = \sqrt{{( {x}_{6} - {x}_{2} )}^{2} + {( {y}_{6} - {y}_{2} )}^{2} + {( {z}_{6} - {z}_{2} )}^{2}} ,$$
a length of a third lifting wire rope of the four lifting wire ropes is
$${C}_{3} = \sqrt{{( {x}_{5} - {x}_{3} )}^{2} + {( {y}_{5} - {y}_{3} )}^{2} + {( {z}_{5} - {z}_{3} )}^{2}} ,$$
a length of a fourth lifting wire rope of the four lifting wire ropes is
$${C}_{4} = \sqrt{{( {x}_{6} - {x}_{4} )}^{2} + {( {y}_{6} - {y}_{4} )}^{2} + {( {z}_{6} - {z}_{4} )}^{2}} ,$$
the height (h₄′) of the first main hook and the height (h₄″) of the second main hook are calculated by setting the length (C₂) of the second lifting wire rope and the length (C₃) of the third lifting wire rope, so as to obtain the length (C₁) of the first lifting wire rope and the length (C₄) of the fourth lifting wire rope, an then an angle (γ) between each of the four lifting wire ropes and the horizontal plane exceeds 60°, the angle (γ) between each of the four lifting wire ropes and the horizontal plane is calculated as follows:
$${γ}_{1} = arcsin ( \frac{{z}_{\text{?}} - {z}_{\text{?}}}{{C}_{1}} ) , {γ}_{2} = arcsin ( \frac{{z}_{\text{?}} - {z}_{\text{?}}}{{C}_{2}} ) ,$$
$${γ}_{3} = arcsin ( \frac{{z}_{\text{?}} - {z}_{\text{?}}}{{C}_{3}} ) , {γ}_{4} = arcsin ( \frac{{z}_{\text{?}} - {z}_{\text{?}}}{{C}_{4}} ) ;$$
$$\text{?} \text{indicates text missing or illegible when filed}$$
and then a load on each of the four lifting wire rope is calculated as follows: since a gravity of the floating crane is vertically downward and the center of the connecting line between the two main hooks coincides with the overall center of gravity position of the quayside container crane in the top view, a load on the first main hook and a load on the second main hook is substantially balanced, it is obtained that a vertical downward load on each of the two main hooks is
$$\frac{Q}{2}$$
when a total weight (Q) of the quayside container crane is obtained according to the design drawing, so that the load on the first lifting wire rope, the load on the second lifting wire rope, the load on the third lifting wire rope and the load on the fourth lifting wire rope are respectively calculated with the first lifting wire rope and the third lifting wire rope sharing a first main hook while the second lifting wire rope and the fourth lifting wire rope sharing the second main hook, based on that a resultant force in a vertical direction of two of the four lifting wire ropes of one of the two main hooks is a lifting weight
$$\frac{Q}{2} ,$$
and a resultant force in a horizontal direction is 0, it is obtained that
$${F}_{\text{?}} \times sin {γ}_{\text{?}} + {F}_{\text{?}} \times sin {γ}_{\text{?}} = \frac{Q}{2} ,$$
$$\text{?} \text{indicates text missing or illegible when filed}$$
F₁×cos γ₁=F₃×cos γ₃;
$${F}_{\text{?}} \times sin {γ}_{\text{?}} + {F}_{\text{?}} \times sin {γ}_{\text{?}} = \frac{Q}{2} ,$$
$$\text{?} \text{indicates text missing or illegible when filed}$$
F₂×cos γ₂=F₄×cos γ₄, the load on the first lifting wire rope, the load on the second lifting wire rope, the load on the third lifting wire rope and the load on the fourth lifting wire rope are obtained by solving equations respectively:
$${F}_{\text{?}} = \frac{Q}{2 ( sin {γ}_{\text{?}} + cos {γ}_{\text{?}} \times tan {γ}_{\text{?}} )} , {F}_{\text{?}} = \frac{Q}{2 ( sin {γ}_{\text{?}} + cos {γ}_{\text{?}} \times tan {γ}_{\text{?}} )} ,$$
$${F}_{\text{?}} = \frac{Q}{2 ( sin {γ}_{\text{?}} + cos {γ}_{\text{?}} \times tan {γ}_{\text{?}} )} , {F}_{\text{?}} = \frac{Q}{2 ( sin {γ}_{\text{?}} + cos {γ}_{\text{?}} \times tan {γ}_{\text{?}} )}$$
$$\text{?} \text{indicates text missing or illegible when filed}$$
according to the load on the first lifting wire rope, the load on the second lifting wire rope, the load on the third lifting wire rope and the load on the fourth lifting wire rope, wherein a lifting wire rope having a diameter with a safety factor above 4 and a shackle with a safety coefficient above 1 are selected by referencing a wire rope breaking force table;
step 6: making preparations before lifting; and
step 7: performing lifting operation at the dock.

2. The full-unit lifting method for the quayside container crane according to claim 1, wherein the length of each of the four lifting wire ropes (C₁-C₄) is 24 m, the angle (Y) between the four lifting wire ropes and the horizontal plane is 60° at minimum, and the height of the main hook to the upper pulley at the boom of the floating crane (h₅) has a minimum value (h₅ₘᵢₙ) of 5 meters.

3. The full-unit lifting method for the quayside container crane according to claim 1, wherein the step 6 further comprises: before lifting, travelling a trolley to a maximum rear extension position of a rear boom, retracting an upper frame of a container hanger to a highest position of the container hanger, parking an elevator at a first floor, locking brakes of the assemblies in such a way, that the trolley and trailer trolley wheels are plugged by wedge blocks, to keep the front boom at a horizontal position; for a travelling mechanism, inserting wooden blocks at rotatable positions of eight-wheel equalizer beams and driving and driven bogies before the lifting, so as to prevent rotation; checking securing and fastening of the assemblies of the quayside container crane to ensure all movable components are fastened; disassembling all anchorages between the quayside container crane and a transport vessel; using two winches on a floating crane vessel to secure two portal legs obliquely opposite the quayside container crane before the lifting, diagonal portal legs of the quayside container crane are pulled by the two winches on the floating crane vessel after the lifting, to maintain a constant inclination angle between the floating crane and the quayside container crane.

4. The full-unit lifting method for the quayside container crane according to claim 1, wherein the step 7 of performing lifting operation at the dock further comprises: 1) after a floating crane vessel arrives at a construction site, the floating crane vessel is positioned within 200 m offshore from a quay front line, the floating crane vessel inclines, a length of an anchor cable is adjusted with reference to barge parameters and water conditions of the dock, to realize operational processes of lifting, shifting, and parking; 2) after the floating crane vessel is positioned, all tools and equipment used during the lifting are comprehensively checked, the floating crane vessel is put into use after it is confirmed that no abnormal condition exists, and whether a lifting point of the equipment is consistent with a diameter of a shackle pin or not is checked, after checking, an angle of the boom is adjusted to a required angle, all mechanical parts of the floating crane vessel are rechecked, and the floating crane vessel is used after being confirmed to be intact; 3) the floating crane vessel is lifted by the two main hooks, the two main hooks are loosened above the equipment to be lifted, rigging suspended on the two main hooks in advance is attached to lifting lugs of the equipment in sequence, and reliability of each connection point is rechecked; 4) after preparation, the lifting is performed, when the lifting is 200 mm away, all starting equipment brakes, a component is suspended on the two main hooks for secondary braking, a static state is maintained, when there is no abnormal condition, the floating crane is started to lift the component to a preset height and is suspended in a static state, the component is horizontally lifted during the lifting, to avoid uneven height discrepancies between the two main hooks; 5) after the component is lifted, a towing belt of a tugboat is used to assist in shifting to an installation berth, and anchor positioning is performed at an installation site, the floating crane vessel is repositioned after arriving at the installation site by adjusting a length and an orientation of the anchor cable, so that the floating crane is positioned above a rail of an installation dock, and the floating crane is kept descending horizontally, so that the equipment in a suspended state is aligned to a position right above a placing point by 10 cm; 6) a placing position of the equipment is approved, the floating crane is commanded to loosen the two main hooks, and the equipment is placed at the placing point; 7) lifting construction is carried out until the lifting is finished, and all lifting tools are retracted and the floating crane vessel is withdrawn.
